(19) United States
(12) Patent Application Publication
(10) Pub. No.: US 2024/0413394 A1
(43) Pub. Date: Dec. 12, 2024

(54) SOLID ELECTROLYTE MATERIAL AND BATTERY USING SAME

(71) Applicant: Panasonic Intellectual Property Management Co., Ltd., Osaka (JP)

(72) Inventors: YOSHIAKI TANAKA, Kyoto (JP); TAKASHI KUBO, Hyogo (JP); KEITA MIZUNO, Osaka (JP)

(21) Appl. No.: 18/813,086

(22) Filed: Aug. 23, 2024

Related U.S. Application Data
(63) Continuation of application No. PCT/JP2022/044223, filed on Nov. 30, 2022.

(30) Foreign Application Priority Data
Mar. 11, 2022 (JP) 2022-038571

(51) Int. Cl. H01M 10/0562; C01G 25/00; C01G 35/00; H01M 10/0585

(52) U.S. Cl. CPC H01M 10/0562; C01G 25/006; C01G 35/006; H01M 10/0585; C01P 2002/50; C01P 2006/40; H01M 2300/0071; H01M 2300/008

(57) ABSTRACT

A solid electrolyte material includes a solid electrolyte and an oxide material. The solid electrolyte includes Li, M, O, and X. M is at least one selected from the group consisting of Nb, Ta, and Zr. X is at least one selected from the group consisting of F, Cl, Br, and I. The oxide material includes at least one selected from the group consisting of oxides of divalent metal elements and oxides of trivalent metal elements. The mass proportion of the oxide material to the solid electrolyte is 1% or more and 50% or less. A battery includes a positive electrode, a negative electrode, and a solid electrolyte layer disposed between the positive electrode and the negative electrode, and at least one selected from the group consisting of the positive electrode, the negative electrode, and the electrolyte layer contains the above solid electrolyte material.

### BACKGROUND

### 1. Technical Field

The present disclosure relates to a solid electrolyte material and a battery using it.

### 2. Description of the Related Art

International Publication No. WO 2020/137153 discloses a solid electrolyte material including Li, M, O, and X. M is at least one element selected from the group consisting of Nb and Ta, and X is at least one element selected from the group consisting of Cl, Br, and I.

### SUMMARY

One non-limiting and exemplary embodiment provides a solid electrolyte material with a reduced generation amount of a halogenated hydrogen gas.

In one general aspect, the techniques disclosed here features a solid electrolyte material including a solid electrolyte and an oxide material, wherein the solid electrolyte includes Li, M, O, and X; M is at least one selected from the group consisting of Nb, Ta, and Zr; X is at least one selected from the group consisting of F, Cl, Br, and I; the oxide material includes at least one selected from the group consisting of oxides of divalent metal elements and oxides of trivalent metal elements; and a mass proportion of the oxide material to the solid electrolyte is 1% or more and 50% or less.

The present disclosure provides a solid electrolyte material with a reduced generation amount of a halogenated hydrogen gas.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 shows a cross-sectional view of a battery according to a second embodiment;

FIG. 2 shows a cross-sectional view of an electrode material according to the second embodiment; and

FIG. 3 shows a schematic diagram of a compression molding dies that is used for evaluating the ion conductivity of a solid electrolyte material.

### DETAILED DESCRIPTIONS

Embodiments of the present disclosure will now be described with reference to drawings.

### First Embodiment

The solid electrolyte material according to a first embodiment includes a solid electrolyte and an oxide material. The solid electrolyte includes Li, M, O, and X. M is at least one selected from the group consisting of Nb, Ta, and Zr. X is at least one selected from the group consisting of F, Cl, Br, and I. The oxide material includes at least one selected from the group consisting of oxides of divalent metal elements and oxides of trivalent metal elements. The mass proportion of the oxide material to the solid electrolyte is 1% or more and 50% or less.

The solid electrolyte material according to the first embodiment can decrease the generation amount of a halogenated hydrogen gas. In addition, the solid electrolyte material according to the first embodiment can have, for example, a practical ion conductivity (for example, a practical ion conductivity that allows to be used in a battery).

The solid electrolyte material according to the first embodiment can have, for example, a high lithium ion conductivity. Here, a high lithium ion conductivity is, for example, 1 mS/cm or more.

When a battery is manufactured in a dry room, the moisture present in the dry room atmosphere and the solid electrolyte may react with each other to generate a gas from the solid electrolyte. In a sulfide solid electrolyte, hydrogen sulfide can be generated. In order to decrease the generation amount of a gas, it is necessary to keep the moisture amount in the dry room low, i.e., to construct a dry room with a low dew point temperature. Accordingly, an expensive dehumidifying apparatus is required, which increases the manufacturing cost of the battery.

The present inventors ascertained that a solid electrolyte containing a halogen and oxygen generates a halogenated hydrogen gas when manufacturing a battery. The solid electrolyte material according to the first embodiment can decrease the generation amount of a halogenated hydrogen gas. Accordingly, a battery using the solid electrolyte material according to the first embodiment can be manufactured at a higher dew point temperature, and the manufacturing cost can be reduced.

The solid electrolyte material according to the first embodiment may be a mixture of the solid electrolyte and the oxide material. In order to decrease the generation amount of a halogenated hydrogen gas, in the solid electrolyte material according to the first embodiment, the solid electrolyte may form a complex with the oxide material. The oxide material formed into the complex can efficiently absorb the hydrogen chloride gas generated from the solid electrolyte. Consequently, the amount of the halogenated hydrogen gas that is discharged to the environment can be decreased. For example, the halogenated hydrogen gas absorbed in the oxide material may react with its oxide material to generate a halide of the metal constituting the oxide and water.

The oxide included in the oxide material is, for example, an oxide different from the positive electrode active material. That is, the oxide material included in the solid electrolyte material according to the first embodiment is, for example, an oxide material other than the positive electrode active material.

The oxide material may include at least one selected from the group consisting of ZnO, CaO, MgO, La₂O₃, and Fe₂O₃. According to the above-mentioned configuration, the halogenated hydrogen gas can be further decreased.

In order to further decrease the halogenated hydrogen gas, the oxide material may include ZnO.

In order to further decrease the halogenated hydrogen gas, in the solid electrolyte material according to the first embodiment, the mass proportion of the oxide material to the solid electrolyte may be 1.6% or more and 39.0% or less.

In order to further decrease the halogenated hydrogen gas, in the solid electrolyte material according to the first embodiment, the mass proportion of the oxide material to the solid electrolyte may be 25% or less.

When the shape of the oxide material is particulate (e.g., spherical), the oxide material may have a median diameter of 1 μm or less or may have a median diameter of 0.1 μm or less.

The median diameter of particles means the particle diameter (d50) corresponding to the 50% accumulated volume in a volume-based particle size distribution. The volume-based particle size distribution can be measured with a laser diffraction measurement apparatus or an image analyzer.

A smaller particle diameter of the oxide material is better. When the oxide material has a small particle diameter, the surface area per unit particle mass increases. As a result, it is possible to absorb a larger amount of a halogenated hydrogen gas.

In order to enhance the ion conductivity of the solid electrolyte material, the solid electrolyte may consist essentially of Li, M, O, and X. Here, the phrase “the solid electrolyte consists essentially of Li, M, O, and X” means that the molar ratio of the sum of the amounts of Li, M, O, and X to the sum of the amounts of all elements constituting the solid electrolyte is 90% or more. As an example, the molar ratio may be 95% or more.

In order to enhance the ion conductivity of the solid electrolyte material, the solid electrolyte may consist of Li, M, O, and X only.

The solid electrolyte may have a composition represented by the following composition formula (1):

LiₐMO_{b}X_{c} (1)
here, 0.1≤a≤7.0, 0.4≤b≤1.9, and 1.0≤c≤11 are satisfied.

In the composition formula (1), 0.3≤a≤5.0, 0.6≤b≤1.6, and 2.0≤c≤9.0 may be satisfied, or 0.6≤a≤3.0, 0.7≤b≤1.2, and 3.0≤c≤7.0 may be satisfied.

In order to enhance the ion conductivity of the solid electrolyte material, in the solid electrolyte, X may include Cl, or X may be Cl.

In order to enhance the ion conductivity of the solid electrolyte material, in the solid electrolyte, the molar ratio of Li to M may be 0.6 or more and 3.0 or less.

The shape of the solid electrolyte is not restricted. Examples of the shape are needle, spherical, and oval spherical shapes. The solid electrolyte may be a particle. The solid electrolyte may be formed so as to have a pellet or planar shape.

When the solid electrolyte material has a particulate shape (e.g., spherical shape), the solid electrolyte may have a median diameter of 0.1 μm or more and 100 μm or less or a median diameter of 0.5 μm or more and 10 μm or less. Consequently, the solid electrolyte and other materials can be well dispersed.

### Manufacturing Method of Solid Electrolyte

The solid electrolyte can be manufactured by the following method.

Raw material powders are provided so as to give a desired composition. Examples of the raw material powder include an oxide, a hydroxide, a halide, and an acid halide.

As one example, in a solid electrolyte constituted of Li, M, O, and X, when M is Ta, X is Cl, and the molar ratios, Li/M and O/X, at the time of mixing the raw materials are 1.0 and 0.2, respectively, Li₂O₂ and TaCl₅ are mixed at a molar ratio, LiO₂:TaCl₅, of 1:2.

M and X are determined by selecting raw material powders. The molar ratios of Li/M and O/X can be adjusted by appropriately selecting the mixing ratios of the raw material powders.

A mixture of raw material powders are heat-treated to obtain a reaction product. In order to suppress evaporation of raw materials by heat treatment, a mixture of raw material powders may be sealed in an airtight container formed from quartz glass or borosilicate glass in vacuum or in an inert gas atmosphere and may be heat-treated. The inert gas atmosphere is, for example, an argon atmosphere or a nitrogen atmosphere. Alternatively, a reaction product may be obtained by mechanochemically reacting (by a mechanochemical milling method) a mixture of raw material powders with each other in a mixing apparatus such as a planetary ball mill. The solid electrolyte included in the solid electrolyte material according to the first embodiment can be obtained by these methods.

Part of M or part of X may be evaporated by heat treatment of the solid electrolyte. Consequently, the values of the molar ratios Li/M and O/X of the resulting solid electrolyte may become larger than the values calculated from the molar ratios of the provided raw material powders. Specifically, the molar ratio Li/M can become larger by about 20% to 70%, and the molar ratio O/X can become larger by about 40% to 75%.

The composition of a solid electrolyte is determined by, for example, ICP emission spectrometry, ion chromatography, an inert gas melting-infrared absorption method, or an EPMA (electron probe micro analyzer) method.

### Manufacturing Method of Solid Electrolyte Material

The solid electrolyte is mixed with an oxide material to obtain a solid electrolyte material.

The mixing method may be a mechanochemical milling method or mortar mixing. Mortar mixing is a method in which powder materials are placed in an agate mortar and are stirred with the mortar and a pestle.

It is only necessary that two types of powders are mixed with each other, and it is even better that powders are uniformly mixed with each other.

### Second Embodiment

A second embodiment will now be described. Matters described in the first embodiment will be omitted as appropriate.

The battery according to the second embodiment includes a positive electrode, an electrolyte layer, and a negative electrode. The electrolyte layer is disposed between the positive electrode and the negative electrode. At least one selected from the group consisting of the positive electrode, the negative electrode, and the electrolyte layer contains the solid electrolyte material according to the first embodiment.

The battery according to the second embodiment has excellent charge and discharge characteristics.

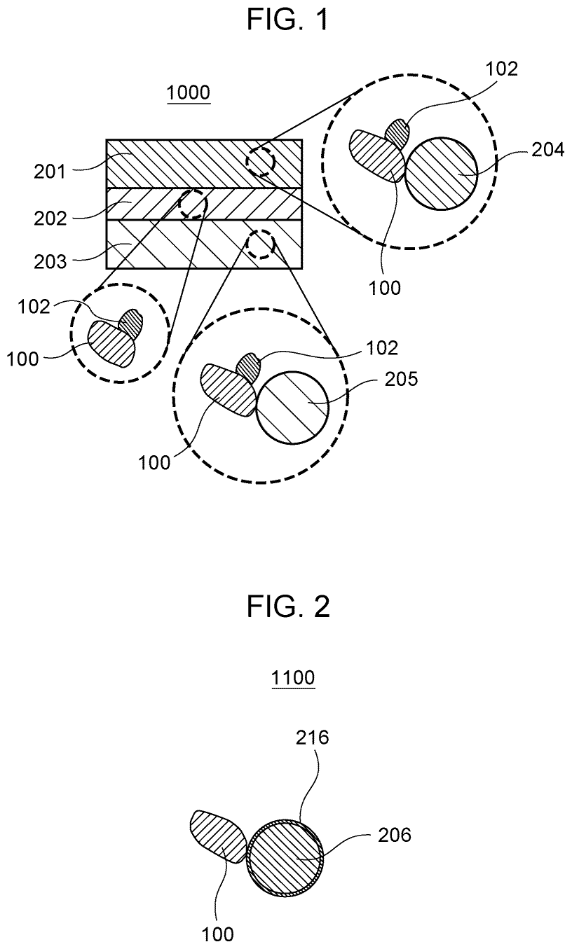

FIG. 1 shows a cross-sectional view of a battery 1000 according to the second embodiment.

The battery 1000 includes a positive electrode 201, an electrolyte layer 202, and a negative electrode 203. The electrolyte layer 202 is disposed between the positive electrode 201 and the negative electrode 203.

The positive electrode 201 contains a positive electrode active material particle 204, a solid electrolyte particle 100, and an oxide particle 102.

The electrolyte layer 202 contains an electrolyte material. The electrolyte material may be, for example, the solid electrolyte material according to the first embodiment. When the electrolyte layer 202 includes the solid electrolyte material according to the first embodiment, the electrolyte layer 202 contains a solid electrolyte particle 100 and an oxide particle 102 as shown in FIG. 1.

The negative electrode 203 contains a negative electrode active material particle 205, a solid electrolyte particle 100, and an oxide particle 102.

The solid electrolyte particle 100 is a particle containing the solid electrolyte that is included in the solid electrolyte material according to the first embodiment. The solid electrolyte particle 100 may be a particle of which the main component is the solid electrolyte that is included in the solid electrolyte material according to the first embodiment. The particle of which the main component is the solid electrolyte that is included in the solid electrolyte material according to the first embodiment means a particle in which the most abundant component is the solid electrolyte that is included in the solid electrolyte material according to the first embodiment. The solid electrolyte particle 100 may be a particle consisting of the solid electrolyte that is included in the solid electrolyte material according to the first embodiment.

The oxide particle 102 is a particle containing the oxide material that is included in the solid electrolyte material according to the first embodiment. The oxide particle 102 may be a particle of which the main component is the oxide material that is included in the solid electrolyte material according to the first embodiment. The particle of which the main component is the oxide material that is included in the solid electrolyte material according to the first embodiment means a particle in which the most abundant component is the oxide material that is included in the solid electrolyte material according to the first embodiment. The oxide particle 102 may be a particle consisting of the oxide material that is included in the solid electrolyte material according to the first embodiment.

The positive electrode 201 contains a material that can occlude and release metal ions such as lithium ions. The positive electrode 201 contains, for example, a positive electrode active material (e.g., the positive electrode active material particle 204).

Examples of the positive electrode active material are a lithium-containing transition metal oxide, a transition metal fluoride, a polyanionic material, a fluorinated polyanionic material, a transition metal sulfide, a transition metal oxysulfide, and a transition metal oxynitride. Examples of the lithium-containing transition metal oxide are Li(Ni,Co,Al)O₂, LiCoO₂, and Li(Ni,Co,Mn)O₂.

In the present disclosure, “(A,B,C)” means “at least one selected from the group consisting of A, B, and C”. Here, A, B, and C all represent elements.

From the viewpoint of the cost and safety of a battery, lithium phosphate may be used as the positive electrode active material.

When the positive electrode 201 contains the solid electrolyte material according to the first embodiment and X is I (i.e., iodine), iron lithium phosphate may be used as the positive electrode active material. The solid electrolyte included in the solid electrolyte material according to the first embodiment that contains I is easily oxidized. The oxidation reaction of the solid electrolyte is suppressed by using iron lithium phosphate as the positive electrode active material. That is, formation of an oxide layer having a low lithium ion conductivity is suppressed. As a result, the battery has a high charge and discharge efficiency.

The positive electrode 201 may also contain a transition metal oxyfluoride as the positive electrode active material in addition to the solid electrolyte material according to the first embodiment. Even if the solid electrolyte included in the solid electrolyte material according to the first embodiment is fluorinated by a transition metal fluoride, a resistive layer is unlikely to be formed. As a result, the battery has a high charge and discharge efficiency.

The transition metal oxyfluoride contains oxygen and fluorine. As an example, the transition metal oxyfluoride may be a compound represented by a composition formula: LiₚMe_{q}OₘFₙ. Here, Me is at least one element selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, and the following mathematical expressions: 0.5≤p≤1.5, 0.5≤q≤1.0, 1≤m<2, and 0<n≤1 are satisfied. An example of such transition metal oxyfluoride is Li_{1.05}(Ni_{0.35}Co_{0.35}Mn_{0.3})_{0.95}O_{1.9}F_{0.1}.

The positive electrode active material particle 204 may have a median diameter of 0.1 μm or more and 100 μm or less. When the positive electrode active material particle 204 has a median diameter of 0.1 μm or more, the positive electrode active material particle 204 and the solid electrolyte particle 100 can form a good dispersion state in the positive electrode 201. Consequently, the charge and discharge characteristics of the battery are improved. When the positive electrode active material particle 204 has a median diameter of 100 μm or less, the lithium diffusion speed in the positive electrode active material particle 204 is improved. Consequently, the battery can operate at a high output.

The positive electrode active material particle 204 may have a median diameter larger than that of the solid electrolyte particle 100. Consequently, the positive electrode active material particle 204 and the solid electrolyte particle 100 can form a good dispersion state.

In order to improve the energy density and output of the battery, the ratio of the volume of the positive electrode active material particle 204 to the sum of the volume of the positive electrode active material particle 204 and the volume of the solid electrolyte particle 100 in the positive electrode 201 may be 0.30 or more and 0.95 or less.

FIG. 2 shows a cross-sectional view of an electrode material 1100 according to the second embodiment. The electrode material 1100 is included in, for example, the positive electrode 201. In order to prevent the electrode active material particle 206 from reacting with the solid electrolyte particle 100, a covering layer 216 may be formed on the surface of the electrode active material particle 206. Consequently, an increase in the reaction overvoltage of the battery can be suppressed. Examples of the covering material contained in the covering layer 216 are a sulfide solid electrolyte, an oxide solid electrolyte, and a halide solid electrolyte.

When the solid electrolyte particle 100 is a sulfide solid electrolyte, the covering material may be the solid electrolyte that is included in the solid electrolyte material according to the first embodiment, and X may be at least one element selected from the group consisting of Cl and Br. Such solid electrolyte material included in the solid electrolyte material according to the first embodiment is hardly oxidized compared to the sulfide solid electrolyte. As a result, an increase in the reaction overvoltage of the battery can be suppressed.

When the solid electrolyte particle 100 is the solid electrolyte included in the solid electrolyte material according to the first embodiment and X includes I, the covering material may be the solid electrolyte included in the solid electrolyte material according to the first embodiment, and X may be at least one element selected from the group consisting of Cl and Br. The solid electrolyte included in the solid electrolyte material according to the first embodiment not containing I is hardly oxidized compared to the solid electrolyte included in the solid electrolyte material according to the first embodiment containing I. As a result, the battery has a high charge and discharge efficiency.

When the solid electrolyte particle 100 is the solid electrolyte included in the solid electrolyte material according to the first embodiment and X includes I, the covering material may include an oxide solid electrolyte. The oxide solid electrolyte may be lithium niobate, which has excellent stability even at a high potential. Consequently, the battery has a high charge and discharge efficiency.

The positive electrode 201 may be composed of a first positive electrode layer containing a first positive electrode active material and a second positive electrode layer containing a second positive electrode active material. Here, the second positive electrode layer is disposed between the first positive electrode layer and an electrolyte layer 202, the first positive electrode layer and the second positive electrode layer contain the solid electrolyte included in the solid electrolyte material according to the first embodiment containing I, and a covering layer 216 is formed on the surface of the second positive electrode active material. According to the above configuration, the solid electrolyte included in the solid electrolyte material according to the first embodiment contained in the electrolyte layer 202 can be suppressed from being oxidized by the second positive electrode active material. As a result, the battery has a high charging capacity. Examples of the covering material contained in the covering layer 206 are a sulfide solid electrolyte, an oxide solid electrolyte, a polymeric solid electrolyte, and a halide solid electrolyte. However, when the covering material is a halide solid electrolyte, I is not included as the halogen element. The first positive electrode active material may be a material that is the same as the second positive electrode active material or a material that is different from the second positive electrode active material.

In order to improve the energy density and output of the battery, the positive electrode 201 may have a thickness of 10 μm or more and 500 μm or less.

The electrolyte layer 202 contains an electrolyte material. The electrolyte material is, for example, a solid electrolyte. The electrolyte layer 202 may be a solid electrolyte layer.

The electrolyte layer 202 may contain the solid electrolyte material according to the first embodiment. The electrolyte layer 202 may consist of the solid electrolyte material according to the first embodiment only.

The solid electrolyte contained in the electrolyte layer 202 may consist of only a solid electrolyte that is different from the solid electrolyte included in the solid electrolyte material according to the first embodiment. Examples of the solid electrolyte that is different from the solid electrolyte included in the solid electrolyte material according to the first embodiment are Li₂MgX′₄, Li₂FeX′₄, Li(Al,Ga,In)X′₄, Li₃(Al,Ga,In)X′₆, and LiI. Here, X′ is at least one element selected from the group consisting of F, Cl, Br, and I.

Hereinafter, the solid electrolyte included in the solid electrolyte material according to the first embodiment is referred to as first solid electrolyte; and the solid electrolyte that is different from the solid electrolyte included in the solid electrolyte material according to the first embodiment is referred to as second solid electrolyte.

The electrolyte layer 202 may contain a second solid electrolyte, in addition to a first solid electrolyte. The first solid electrolyte and the second solid electrolyte may be uniformly dispersed.

The electrolyte layer 202 may have a thickness of 1 μm or more and 100 μm or less. When the electrolyte layer 202 has a thickness of 1 μm or more, the positive electrode 201 and the negative electrode 203 are less likely to short circuit. When the electrolyte layer 202 has a thickness of 100 μm or less, the battery can operate at a high output.

Another electrolyte layer may be further provided between the electrolyte layer 202 and the negative electrode 203. For example, when the electrolyte layer 202 contains the first solid electrolyte, in order to more stably maintain the high ion conductivity of the solid electrolyte, an electrolyte layer constituted of another solid electrolyte that is more electrochemically stable than the solid electrolyte may be further provided.

The negative electrode 203 contains a material that can occlude and release metal ions (e.g., lithium ions). The negative electrode 203 contains, for example, a negative electrode active material (e.g., the negative electrode active material particle 205).

Examples of the negative electrode active material are a metal material, a carbon material, an oxide, a nitride, a tin compound, and a silicon compound. The metal material may be a single metal or may be an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material are silicon (i.e., Si), tin (i.e., Sn), a silicon compound, and a tin compound.

The negative electrode active material may be selected based on the reduction resistance of the solid electrolyte included in the negative electrode 203. When the negative electrode 203 contains the first solid electrolyte, a material that can occlude and release lithium ions at 0.27 V or more with respect to lithium may be used as the negative electrode active material. When the negative electrode active material is such a material, it is possible to suppress the first solid electrolyte included in the negative electrode 203 from being reduced. As a result, the battery has a high charge and discharge efficiency. Examples of the material are titanium oxide, indium metal, and a lithium alloy. Examples of the titanium oxide are Li₄Ti₅O₁₂, LiTi₂O₄, and TiO₂.

The negative electrode active material particle 205 may have a median diameter of 0.1 μm or more and 100 μm or less. When the negative electrode active material particle 205 has a median diameter of 0.1 μm or more, the negative electrode active material particle 205 and the solid electrolyte particle 100 can form a good dispersion state in the negative electrode 203. Consequently, the charge and discharge characteristics of the battery are improved. When the negative electrode active material particle 205 has a median diameter of 100 μm or less, the lithium diffusion speed in the negative electrode active material particle 205 is improved. Consequently, the battery can operate at a high output.

The negative electrode active material particle 205 may have a median diameter larger than that of the solid electrolyte particle 100. Consequently, the negative electrode active material particle 205 and the solid electrolyte particle 100 can form a good dispersion state.

In order to improve the energy density and output of the battery, the ratio of the volume of the negative electrode active material particle 205 to the sum of the volume of the negative electrode active material particle 205 and the volume of the solid electrolyte particle 100 in negative electrode 203 may be 0.30 or more and 0.95 or less.

The electrode material 1100 shown in FIG. 2 may be contained in the negative electrode 203. In order to prevent the solid electrolyte particle 100 from reacting with the negative electrode active material (i.e., the electrode active material particle 206), a covering layer 216 may be formed on the surface of the electrode active material particle 206. Consequently, the battery has a high charge and discharge efficiency. Examples of the covering material contained in the covering layer 216 are a sulfide solid electrolyte, an oxide solid electrolyte, a polymeric solid electrolyte, and a halide solid electrolyte.

When the solid electrolyte particle 100 is a first solid electrolyte, the covering material may be a sulfide solid electrolyte, an oxide solid electrolyte, or a polymeric solid electrolyte. An example of the sulfide solid electrolyte is Li₂S—P₂S₅. An example of the oxide solid electrolyte is trilithium phosphate. Examples of the polymeric solid electrolyte are polyethylene oxide and a conjugated compound of a lithium salt. An example of the polymeric solid electrolyte is lithium bis(trifluoromethanesulfonyl)imide.

In order to improve the energy density and output of the battery, the negative electrode 203 may have a thickness of 10 μm or more and 500 μm or less.

At least one selected from the group consisting of the positive electrode 201, the electrolyte layer 202, and the negative electrode 203 may contain a second solid electrolyte in order to enhance the ion conductivity. Examples of the second solid electrolyte are a sulfide solid electrolyte, an oxide solid electrolyte, a halide solid electrolyte, and an organic polymeric solid electrolyte.

In the present disclosure, the term “sulfide solid electrolyte” means a solid electrolyte containing sulfur. The term “oxide solid electrolyte” means a solid electrolyte containing oxygen. The oxide solid electrolyte may contain an anion (excluding a sulfur anion and a halogen anion) in addition to oxygen. The term “halide solid electrolyte” means a solid electrolyte containing a halogen element and not containing sulfur. The halide solid electrolyte may contain oxygen in addition to a halogen element.

Examples of the sulfide solid electrolyte are Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂.

Examples of the oxide solid electrolyte are:
(i) an NASICON-type solid electrolyte, such as LiTi₂(PO₄)₃ or an element substitute thereof;
(ii) a perovskite-type solid electrolyte, such as (LaLi)TiO₃;
(iii) an LISICON-type solid electrolyte, such as Li₁₄ZnGe₄O₁₆, Li₄SiO₄, LiGeO₄, or an element substitute thereof;
(iv) a garnet-type solid electrolyte, such as Li₇La₃Zr₂O₁₂ or an element substitute thereof; and
(v) Li₃PO₄ or an N-substitute thereof.

Examples of the halide solid electrolyte are compounds represented by LiₐMe′_{b}Y_{c}Z₆. Here, mathematical expressions: a+mb+3c=6 and c>0 are satisfied. Me′ is at least one selected from the group consisting of metal elements other than Li and Y and metalloid elements. Z is at least one element selected from the group consisting of F, Cl, Br, and I. The value of m represents the valence of Me′.

The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded). Me′ may be at least one element selected from the group consisting of Mg, Ca, Sr, Ba, Zn, Sc, Al, Ga, Bi, Zr, Hf, Ti, Sn, Ta, and Nb.

Examples of the halide solid electrolyte are Li₃YCl₆ and Li₃YBr₆.

When the electrolyte layer 202 contains the first solid electrolyte, the negative electrode 203 may contain a sulfide solid electrolyte. Consequently, the sulfide solid electrolyte, which is electrochemically stable against the negative electrode active material, suppresses the first solid electrolyte and the negative electrode active material from becoming in contact with each other. As a result, the battery has low internal resistance.

Examples of the organic polymeric solid electrolyte are a polymeric compound and a compound of a lithium salt. The polymeric compound may have an ethylene oxide structure. A polymeric compound having an ethylene oxide structure can contain a large amount of a lithium salt and can therefore have a higher ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte solution, a gel electrolyte, or an ionic liquid for the purpose of facilitating the transfer of lithium ions and improving the output characteristics of the battery.

The nonaqueous electrolyte solution includes a nonaqueous solvent and a lithium salt dissolved in the nonaqueous solvent. Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, in a range of 0.5 mol/L or more and 2 mol/L or less.

As the gel electrolyte, a polymer material impregnated with a nonaqueous electrolyte solution can be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium or tetraalkylphosphonium;
(ii) an aliphatic cyclic ammonium, such as a pyrrolidinium, a morpholinium, an imidazolinium, a tetrahydropyrimidinium, a piperazinium, or a piperidinium; and
(iii) a nitrogen-containing heterocyclic aromatic cation, such as a pyridinium or an imidazolium.

Examples of the anion included in the ionic liquid are PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer can also be used as the binder. Examples of the binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from these materials may be used.

At least one selected from the group consisting of the positive electrode 201 and the negative electrode 203 may contain a conductive assistant in order to enhance the electron conductivity.

Examples of the conductive assistant are:
(i) graphite, such as natural graphite or artificial graphite;
(ii) carbon black, such as acetylene black or Ketjen black;
(iii) conductive fibers, such as carbon fibers or metal fibers;
(iv) carbon fluoride;
(v) metal powders, such as aluminum;
(vi) conductive whiskers, such as zinc oxide or potassium titanate;
(vii) a conductive metal oxide, such as titanium oxide; and
(viii) a conductive polymeric compound, such as polyaniline, polypyrrole, or polythiophene.
   In order to reduce the cost, the conductive assistant of the above (i) or (ii) may be used.

Examples of the shape of the battery according to the second embodiment are coin type, cylindrical type, square type, sheet type, button type, flat type, and stacked type.

### EXAMPLES

The present disclosure will now be described in more detail with reference to Examples.

### Example 1

### Production of Solid Electrolyte

Li₂O, LiOH, and TaCl₅ were provided as raw material powders at a molar ratio of Li₂O:LiOH:TaCl₅=0.4:0.4:1.0 in a dry atmosphere having a dew point of less than or equal to −30° C. (hereinafter, referred to as “dry atmosphere”). These raw material powders were pulverized and mixed in a mortar to obtain a powder mixture. The powder mixture was placed in a quartz glass container filled with argon gas and was heat-treated at 350° C. for 3 hours. The resulting heat-treated product was pulverized in an agate mortar. Thus, a solid electrolyte of Example 1 was obtained. The molar ratio Li/M was 0.9, and the molar ratio O/X was 0.19. The molar ratios Li/M and O/X were determined by measuring Li and M by ICP emission spectral analysis, X by ion chromatography, and O by an inert gas fusion-infrared absorption method. The apparatuses used for measurement of the composition were an ICP emission spectral analyzer, an ion chromatographic apparatus, and an oxygen analyzer.

### Production of Solid Electrolyte Material

The solid electrolyte of Example 1 and ZnO were provided in the dry atmosphere such that the mass proportion of ZnO to the solid electrolyte was 1.6%. These materials were pulverized and mixed in a mortar to obtain a solid electrolyte material of Example 1.

The average particle diameter of ZnO was about 20 nm.

### Evaluation of Ion Conductivity

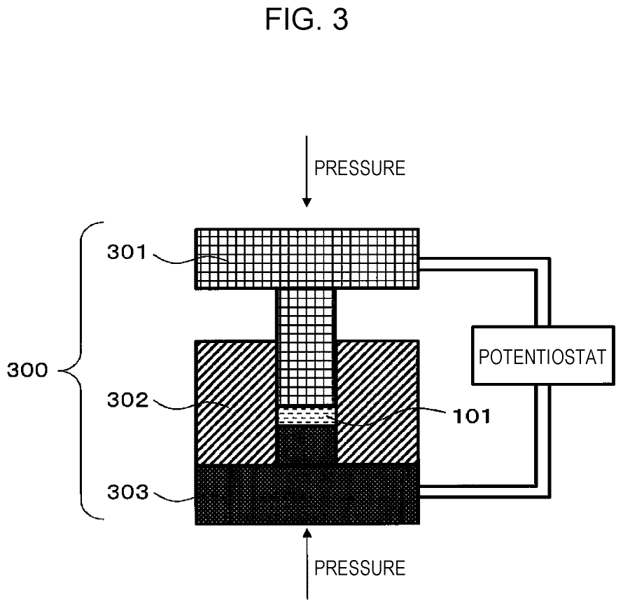

FIG. 3 shows a schematic diagram of a compression molding dies 300 that is used for evaluating the ion conductivity of a solid electrolyte material.

The compression molding dies 300 included a punch upper part 301, a die 302, and a punch lower part 303. The die 302 was formed from insulating polycarbonate. The punch upper part 301 and the punch lower part 303 were both formed from electron-conductive stainless steel.

The ion conductivity of the solid electrolyte material of Example 1 was measured using the compression molding dies 300 shown in FIG. 3 by the following method.

The powder of the solid electrolyte material of Example 1 (i.e., the powder 101 of the solid electrolyte material in FIG. 3) was loaded inside the compression molding dies 300 in the dry atmosphere. A pressure of 300 MPa was applied to the solid electrolyte material of Example 1 inside the compression molding dies 300 using the punch upper part 301.

While applying the pressure, the compression molding dies 300 was connected to a potentiostat (Princeton Applied Research, VersaSTAT4) equipped with a frequency response analyzer through the punch upper part 301 and the punch lower part 303. The punch upper part 301 was connected to the working electrode and the potential measurement terminal. The punch lower part 303 was connected to the counter electrode and the reference electrode. The ion conductivity of the solid electrolyte material of Example 1 was measured by an electrochemical impedance measurement method at room temperature. As a result, the ion conductivity measured at 22° C. was 5.1 mS/cm.

### Measurement of Hydrogen Chloride Gas

The solid electrolyte material (30 mg) of Example 1 was preserved in a 1-L glass container filled with the dry atmosphere for 5 minutes. Subsequently, a hydrogen chloride gas detection tube (manufactured by GASTEC Corporation, 14M) was introduced into the glass container through the inlet port provided to the container, and the hydrogen chloride gas concentration was measured. As a result, the measured hydrogen chloride gas concentration was 79 ppm/L.

### Examples 2 to 9 and Comparative Example 1

### Production of Solid Electrolyte Material

In Examples 2 to 5, solid electrolyte materials of Examples 2 to 5 were obtained as in Example 1 except for the mass proportion of ZnO to the solid electrolyte. The mass proportions are shown in Table 1.

In Example 6, La₂O₃ was used instead of ZnO. The mass proportion of La₂O₃ to the solid electrolyte was 20.1%. A solid electrolyte material of Example 6 was obtained as in Example 1 except for the above matter.

The average particle diameter of La₂O₃ was about 100 nm.

In Example 7, CaO was used instead of ZnO. The mass proportion of CaO to the solid electrolyte was 10.3%. A solid electrolyte material of Example 7 was obtained as in Example 1 except for the above matter.

The average particle diameter of CaO was about 160 nm.

In Example 8, MgO was used instead of ZnO. The mass proportion of MgO to the solid electrolyte was 11.1%. A solid electrolyte material of Example 8 was obtained as in Example 1 except for the above matter.

The average particle diameter of MgO was about 50 nm.

In Example 9, Fe₂O₃ was used instead of ZnO. The mass proportion of Fe₂O₃ to the solid electrolyte was 16.2%. A solid electrolyte material of Example 9 was obtained as in Example 1 except for the above matter.

The average particle diameter of Fe₂O₃ was about 50 nm.

In Comparative Example 1, the oxide material was not used. That is, the solid electrolyte material of Comparative Example 1 consisted of the solid electrolyte of Example 1.

### Evaluation of Ion Conductivity

The ion conductivity of each of the solid electrolyte materials of Examples 2 to 9 and Comparative Example 1 was measured as in Example 1. The measurement results are shown in Table 1.

### Measurement of Hydrogen Chloride Gas

Hydrogen chloride of each of the solid electrolyte materials of Examples 2 to 9 and Comparative Example 1 was measured as in Example 1. The measurement results are shown in Table 1.

### Example 10 and Comparative Example 2

### Production of Solid Electrolyte

In Example 10 and Comparative Example 2, Li₂O, Li₂O₂, and ZrCl₄ were provided as raw material powders at a molar ratio of Li₂O:Li₂O₂:ZrCl₄=0.6:1.4:2 in the dry atmosphere. These raw material powders were pulverized and mixed in a mortar to obtain a powder mixture. The obtained powder mixture was subjected to milling treatment with a planetary ball mill at 600 rpm for 24 hours. Thus, the solid electrolyte of Example 10 and Comparative Example 2 was obtained. The composition of the obtained solid electrolyte was analyzed by the same method as in Example 1, and the molar ratio Li/M was determined from the analyzed composition. The molar ratio Li/M was 2.0.

### Production of Solid Electrolyte Material

In Example 10, the solid electrolyte of Example 10 and ZnO were provided such that the mass proportion of ZnO to the solid electrolyte was 12.3%. A solid electrolyte material of Example 10 was obtained as in Example 1 except for the above matter.

In Comparative Example 2, the oxide material was not used. That is, the solid electrolyte material of Comparative Example 2 consisted of the solid electrolyte of Example 10.

TABLE 1

| | | | | Hydrogen | |
|---|---|---|---|---|---|
| | Constituent | | Proportion | chloride gas | Ion |
| | element of | Oxide | of oxide | generation | conductivity |
| | solid electrolyte | material | material (mass %) | amount (ppm/L) | (mS/cm) |
| Example 1 | Li, Ta, O, Cl | ZnO | 1.6 | 79 | 5.1 |
| Example 2 | Li, Ta, O, Cl | ZnO | 8.2 | 45 | 3.6 |
| Example 3 | Li, Ta, O, Cl | ZnO | 17.3 | 1 | 2.4 |
| Example 4 | Li, Ta, O, Cl | ZnO | 23.3 | 0 | 1.1 |
| Example 5 | Li, Ta, O, Cl | ZnO | 39.0 | 0 | 0.2 |
| Example 6 | Li, Ta, O, Cl | La₂O₃ | 20.1 | 60 | 2.1 |
| Example 7 | Li, Ta, O, Cl | CaO | 10.3 | 65 | 1.6 |
| Example 8 | Li, Ta, O, Cl | MgO | 11.1 | 70 | 2.0 |
| Example 9 | Li, Ta, O, Cl | Fe₂O₃ | 16.2 | 75 | 1.7 |
| Example 10 | Li, Zr, O, Cl | ZnO | 12.3 | 11 | 1.6 |
| Comparative Example 1 | Li, Ta, O, Cl | — | 0 | 90 | 5.6 |
| Comparative Example 2 | Li, Zr, O, Cl | — | 0 | 20 | 2.2 |

### Consideration

As obvious from Table 1, in comparing Examples 1 to 9 and Comparative Example 1 in which the constituent elements of the solid electrolytes were the same “Li, Ta, O, and Cl”, the amounts of the generated hydrogen chloride gas in the solid electrolyte materials of Examples 1 to 9 containing an oxide material were smaller than that in the solid electrolyte material of Comparative Example 1 not containing the oxide material. In comparison of the solid electrolyte materials of Example 10 and Comparative Example 2 in which the constituent elements of the solid electrolytes were the same “Li, Zr, O, and Cl”, the amount of the generated hydrogen chloride gas in the solid electrolyte material of Example 10 containing an oxide material was smaller than that in the solid electrolyte material of Comparative Example 2 not containing the oxide material.

As obvious from comparing Example 3 and Comparative Examples 1 and 2, the solid electrolyte material containing 17.3 mass % of ZnO has low gas generation and high ion conductivity.

As described above, the solid electrolyte material according to the present disclosure can decrease the generation amount of halogenated hydrogen gas and also can have a higher lithium ion conductivity. Accordingly, the solid electrolyte material according to the present disclosure is a material that is suitable for proving a battery having excellent charge and discharge characteristics at a low manufacturing cost.

The battery of the present disclosure is used in, for example, an all-solid lithium ion secondary battery.

What is claimed is:

1. A solid electrolyte material comprising a solid electrolyte and an oxide material, wherein
the solid electrolyte includes Li, M, O, and X,
M is at least one selected from the group consisting of Nb, Ta, and Zr,
X is at least one selected from the group consisting of F, Cl, Br, and I,
the oxide material includes at least one selected from the group consisting of oxides of divalent metal elements and oxides of trivalent metal elements, and
a mass proportion of the oxide material to the solid electrolyte is 1% or more and 50% or less.

2. The solid electrolyte material according to claim 1, wherein
the oxide material includes at least one selected from the group consisting of ZnO, MgO, CaO, La₂O₃, and Fe₂O₃.

3. The solid electrolyte material according to claim 2, wherein
the oxide material includes ZnO.

4. The solid electrolyte material according to claim 1, wherein
the mass proportion of the oxide material to the solid electrolyte is 1.6% or more and 39.0% or less.

5. The solid electrolyte material according to claim 1, wherein
the mass proportion of the oxide material to the solid electrolyte is 25% or less.

6. The solid electrolyte material according to claim 1, wherein
the solid electrolyte has a composition represented by a following composition formula (1):
LiₐMO_{b}X_{c} (1)
here, 0.1≤a≤7.0, 0.4≤b≤1.9, and 1.0≤c≤11 are satisfied.

7. The solid electrolyte material according to claim 1, wherein
in the solid electrolyte, X includes Cl.

8. The solid electrolyte material according to claim 1, wherein
in the solid electrolyte, a molar ratio of Li to M is 0.6 or more and 3.0 or less.

9. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer contains the solid electrolyte material according to claim 1.
